(19) United States
(12) Patent Application Publication
(10) Pub. No.: US 2003/0099918 A1
(43) Pub. Date: May 29, 2003

(54) Personal denture remover

(76) Inventor: Eva De Luca, Bronx, NY (US)

Correspondence Address: EVA DE LUCA, 3510 Bainbridge Ave. Apt. 2F, BRONX, NY, 10467-1419, US

(21) Appl. No.: 09/991,594

(22) Filed: Nov. 23, 2001

(51) Int. Cl. A61C 3/00

(52) U.S. Cl. 433/141

(57) ABSTRACT

The invention of the Personal Denture Remover solves a problem (the inabilty of most, if not all, denture users to easily remove their own dentures) that was never before resolved. The invention provides a convenient, useful and easy advantage that was never before offered to denture users, and it solved a long-felt, long-existing, unresolved need. The invention is an article of a material, such as metal or plastic, shaped or bent into a loop for the insertion of a denture users finger at one end and a hook shaped at the other end which is to be inserted over a uses denture(s) for an easy removal of the denture(s) from the user's mouth,

### CROSS REFERENCE TO RELATED APPLICATION

Provisional U.S. patent application of EVA DE LUCA FOR PERSONAL DENTURE REMOVER, Number JC 714 U,S. PTO No. 60/251702, filed Dec. 7, 2000.

### BACKGROUND OF INVENTION

Prior to my invention, I was and still am a user of an upper den, and suffered great difficulty in removing it. I communicated with many manufacturers, wholesalers, and professionals, who were in some manner connected with dentures. Noting was available. Nor, was any professional advice affirmative. I further had a patent search made. Results of this search in 1976-2000 db for “removal denture,” 28 patents, revealed no prior art whatsoever.

### STATEMENT REGARDING FEDERALLY SPONSORED RESEARCH OR DEVELOPMENT

Not applicable.

### REFERENCE TO SEQUENCE LISTING, A TABLE, OR COMPUTER LISTING COMPACT DISC APPENDIX

No applicable.

### BRIEF SUMMARY OF INVENTION

My invention is specifically a denture removal article which provides for personal removal of dentures, emabling dentures to be easily and expeditiously removed from mouth of a user of dentures, together with the advantages of being highly reliable, no moving parts, compact, convenient and economical,

### BRIEF DESCRIPTION OF THE TWO VIEWS OF THE DRAWING

Drawings consist of one page with two figures:

FIG. 1 shows overall side view.

FIG. 2 shows overall top view, including “a” top of hook.

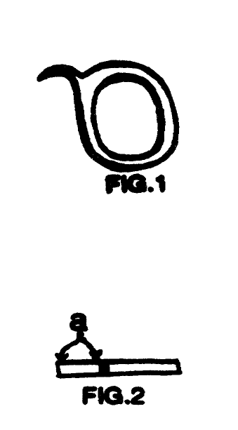

### DESCRIPTION OF FIGS. 1 & 2:

FIG. 1 illustrates the loop which can be manufactured of either metal or plastic, with space herein to receive index finger. It also illustrates extended hook at top end of loop.

FIG. 2 shows overall top of loop with “a” illustrating extended hook.

### OPERATION OF INVENTION

The manner of using the personal denture remover is simple. The loops are to be used as a pair to facilitate the loosening of the denture from the left and right sides of the gums. To remove an upper denture, a user must insert both index fingers separately into the two loops. The loops are ten inserted into the mouth, with the hooks reaching over the top of the denture, while holding the bottom of each loop with a thumb. A gentle tug downward loosens an upper denture, without a struggle normally associated with this task. To loosen a lower denture, the position is reversed, pulling the denture upward,

1. What I claim as my invention is a personal denture remover which can be used with ease by a denture user to self-remove a denture, comprising an article of material, such as metal or plastic, shaped or bent into a loop for the insertion of a users finger at one end and a hook at the other end to be inserted over user's denture(s) for removal from user's mouth.
